(19) United States
(12) Patent Application Publication
(10) Pub. No.: US 2002/0102061 A1
(43) Pub. Date: Aug. 1, 2002

(54) Planar waveguide optical switch and method of producing same

(76) Inventor: Robert Lang, Pleasanton, CA (US)

Correspondence Address: KUDIRKA & JOBSE, LLP, ONE STATE STREET, SUITE 1510, BOSTON, MA, 02109, US

(21) Appl. No.: 09/742,883

(22) Filed: Dec. 20, 2000

Related U.S. Application Data
(60) Provisional application No. 60/224,192, filed on Aug. 9, 2000.

(51) Int. Cl. G02B 6/35; G02B 6/26

(52) U.S. Cl. 385/50; 385/16

(57) ABSTRACT

An optical switch is fabricated on a single substrate and switches planar waveguides into and out of alignment with each other. The switch is constructed by selective deposition and etching of layers that make up the desired waveguides and physical structures of the switch. The physical structures include a movable structure upon which one of the waveguides resides, the movable structure being freed from the substrate by deep etching underneath it. A heat source may be used to provide heat to the movable structure, which causes its thermal expansion and resulting movement of the waveguide on it into or out of alignment with another waveguide. A third waveguide may be located so as to align with the waveguide on the movable structure when it is at an ambient temperature.

### FIELD OF THE INVENTION

This invention relates generally to optical switching and, more specifically, to optical switching of a planar waveguide.

### BACKGROUND OF THE INVENTION

In the field of optical signal communication, it is often desirable to select between two or more optical signals to be transmitted along a single optical waveguide. The different optical signals may represent, for example, different communications signals on a telecommunications system. Similarly, it is often desirable to select between two possible waveguides along which a given optical signal will be transmitted. In such a case, the switching may be to direct a certain optical signal along a selected one of multiple output paths. For such uses, as well as others, it would be desirable to have a high-speed optical switch that was compact, efficient and easy to produce.

In the past, optical switches have used a number of different techniques to perform the desired switching operation. A simple switch configuration, often referred to as a “1×2 switch” can be operated to connect one optical waveguide to either one of two other optical waveguides. One method of switching is to have a region through which an optical signal being switched must pass, the region having a refractive index or change in refractive index upon which the directing of the optical signal to a given waveguide depends. By supplying some means by which the refractive index of this region may be changed, the path of the optical signal is likewise changed, directing it to a different output, for example.

Another type of optical switching relies on a physical movement of one or more switch components to select the position of an optical signal being switched. In some cases, these switches have made use of actuators that move an optical fiber waveguide from a first position to a second position, the two positions realizing coupling, respectively, between two different output fibers. In another actuator-type switch, a coupling lens positioned between a source fiber and multiple output fibers is moved to change the focus of the signal being coupled from one output fiber to another. In such devices, to initiate switching, force is applied to a movable component in one of several ways. For example, a piezoelectric module may be used that undergoes a physical change in the presence of an electrical switching signal. Such a device is shown in U.S. Pat. No. 4,303,302. In another switch type, materials with known coefficients of thermal expansion are arranged such that the heating of one or more of these materials causes a physical movement of one point relative to another. In U.S. Pat. No. 5,446,811, such a configuration is used to cause the movement of an optical fiber secured to the displaced material, thereby enabling the switching.

### SUMMARY OF THE INVENTION

In accordance with the present invention, an optical switch is provided that is fabricated on a single substrate. A first planar waveguide and a second planar waveguide are both fabricated on the substrate, and the second waveguide is provided with a degree of freedom that allows it to be moved between two positions. In a first position, the second waveguide is aligned with the first waveguide such that an optical signal can be coupled between them. In the second position, the second waveguide is not aligned with the first waveguide. However, in a preferred embodiment, the second position places the second waveguide in alignment with a third planar waveguide that is also fabricated on the substrate.

The present invention provides for an optical switch that can be produced as a single fabrication process. The waveguides may be part of a layer of material that is deposited on the substrate and etched to form the desired core regions of planar waveguides. A cladding material is also deposited on the substrate, typically prior to and after the deposition of the waveguide material, so that it completely surrounds the planar waveguides. This provides the necessary refractive index boundary to allow a total internal reflection condition within the waveguides. Selective etching of the cladding material layer allows the formation of a movable structure to which the second waveguide is rigidly fixed, preferably by its residing within it. The movable structure may be fixed relative to a remainder of the cladding material layer, and a portion of the substrate below the movable structure is typically removed to allow it limited movement in a space above the substrate. A physical stop may also be used, and is particularly beneficial when the switch relies on movement caused by thermal expansion. The stop is located so as to limit the motion of the movable structure in a direction in which the structure moves when changing the alignment between the second waveguide and the first waveguide. That is, when the movable structure contacts the stop, the second waveguide is properly aligned with the first waveguide. Further increases in the force driving the movement of the movable structure therefore do not change the alignment between the waveguides.

In a preferred embodiment, switching is implemented by using a heat source to heat the movable structure, which then moves between different positions in response to its own thermal expansion. Such a heat source may consist of one or more conductive pads that may be deposited on the substrate, typically on top of one or more previously deposited layers. A resistance heating material may be integrated into the movable structure, and connected to the heating pads that, if provided with an electrical potential, cause an electrical current to pass through the heating material. This, in turn, results in resistive heating of the movable structure.

### BRIEF DESCRIPTION OF THE DRAWINGS

The above and further advantages of the invention may be better understood by referring to the following description in conjunction with the accompanying drawings in which:

FIG. 1 is a schematic top view of an optical switch according to the present invention; and

FIGS. 2A-2G depict a cross sectional schematic view of the fabrication stages of a switch like that shown in FIG. 1.

### DETAILED DESCRIPTION

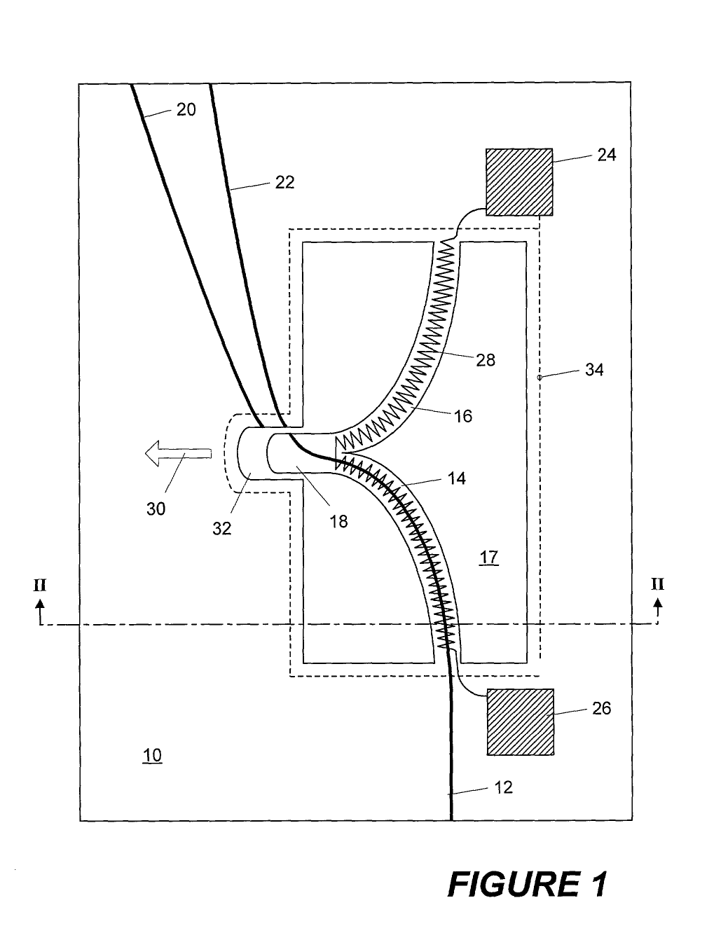

Shown in FIG. 1 is a 1×2 optical switch that uses a thermally actuated switching element to change the position of a planar waveguide and thereby effectuate the desired switching action. The switch is fabricated from a single substrate 10 that may be, for example, a semiconductor material such as silicon. An input optical waveguide 12 is fabricated on the substrate 10 and passes through a portion of the switch that is free to move relative to the substrate. The movable portion includes two “arms” 14, 16 which together form a “wishbone” shape. Each of the arms is fixed to the substrate at one end, and together form a single laterally moving segment 18 at the other end. Preferably, each arm 14, 16, at an ambient operating temperature, has an arcuate shape, as shown in the figure. As shown, the arms reside in an open area 17 of the material layer from which they are fabricated.

The input waveguide 12 is a planar waveguide that follows along arm 14 to segment 18, where it ends and is transmitted across a small gap to one of two output waveguides 20, 22. Preferably, the respective waveguides are angled so as to achieve Brewster's angle at the coupling point, as is known in the art. Each of the two output waveguides 20, 22 is arranged to convey the optical signal from the input waveguide 12 to a different destination. Which of the waveguides receives the output from the input waveguide depends on the relative positioning of the movable portion formed by the arms 14, 16. The position of the arms shown in FIG. 1 is at an ambient operating temperature, and results in an optical signal transmitted along input waveguide 12 to be coupled to output waveguide 22. Those skilled in the art will understand that the drawing in FIG. 1 is not to scale, but rather is for illustrative purposes. In order to switch to the other output, i.e., output waveguide 20, heat is input to the arms 14, 16.

The heating of arms 14, 16 is accomplished using a heater consisting of heater pads 24, 26 and a thermal element 28 that runs on top of or through the arms 14, 16. The heater element may be a simple resistance heater, such that an electrical source could be applied to pads 24, 26 to provide the desired heating of the material. As the temperature of the arms 14, 16 increases, the material from which the arms are fabricated expands. The wishbone shape of the arms results in them having a relatively high degree of stiffness in a first direction, while having significantly more flexibility in a perpendicular direction, which, in the figure, is the direction shown by arrow 30. Thus, as the arms heat up, the segment 18 moves quickly to a second position in which the input waveguide 12 is aligned with output waveguide 20. A mechanical stop 32 is used to control the movement of the segment 18 in the direction of the arrow 30, so that it is not necessary to precisely control the temperature of the arms 14, 16. If the heater is overdriven, additional flexing of the arms results, but the input waveguide 12 remains aligned with output waveguide 20. It is recognized that the deflection of the arms 14, 16 may result in the introduction of a certain degree of birefringence into the input waveguide. It may be desirable to design the waveguide with a predetermined amount of birefringence that is reduced when activation of the switch puts the waveguide under stress. The birefringence may also be designed into the waveguide in such a way that it is minimized when the switch is at a position halfway between the two output waveguides, so that the birefringence in each of the switch positions is approximately equal.

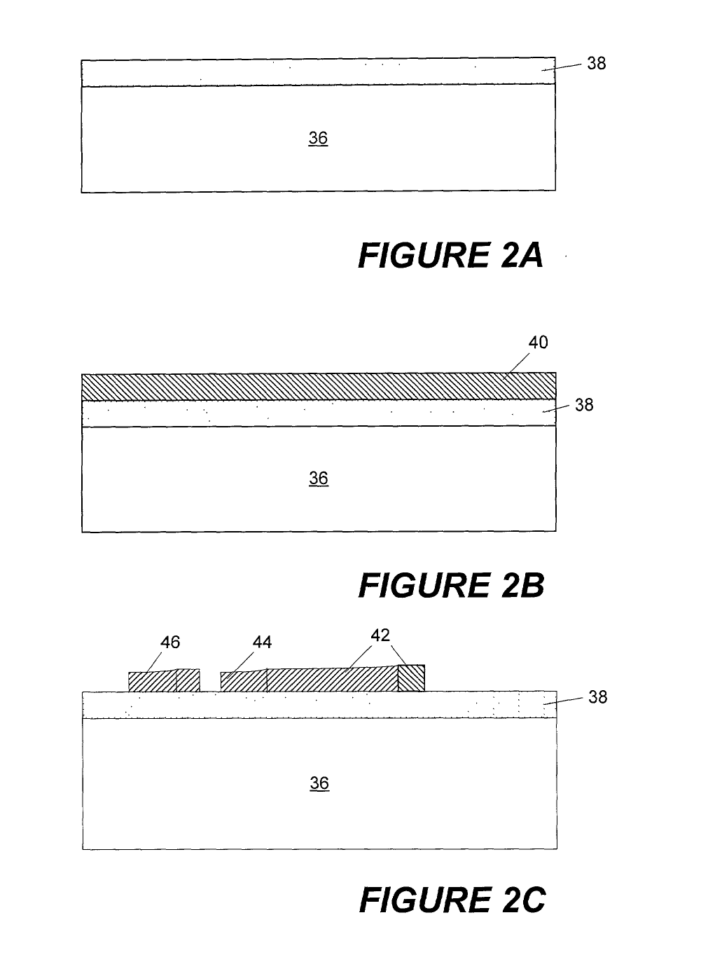

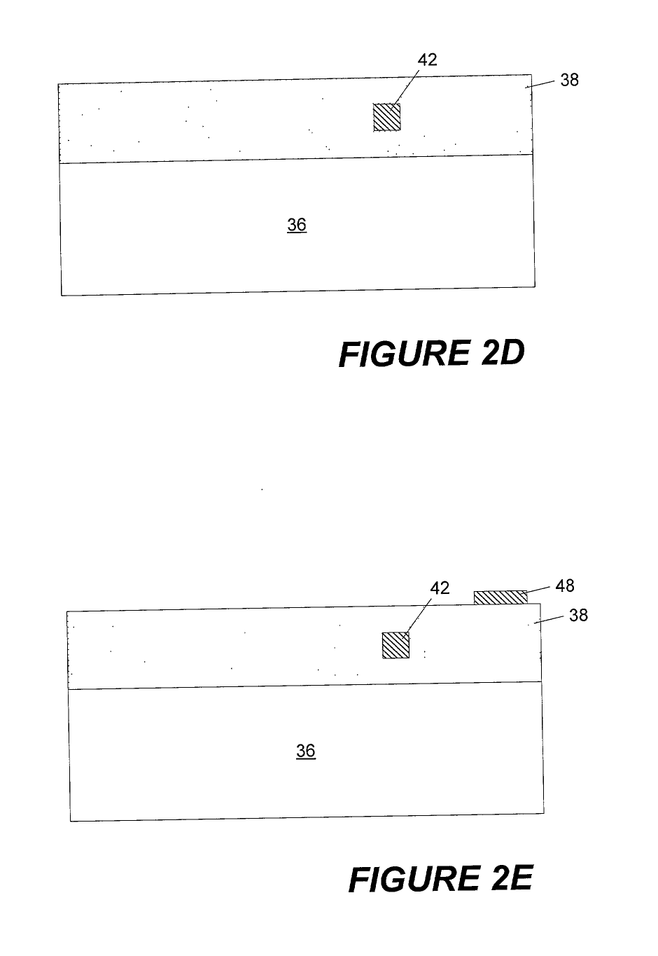

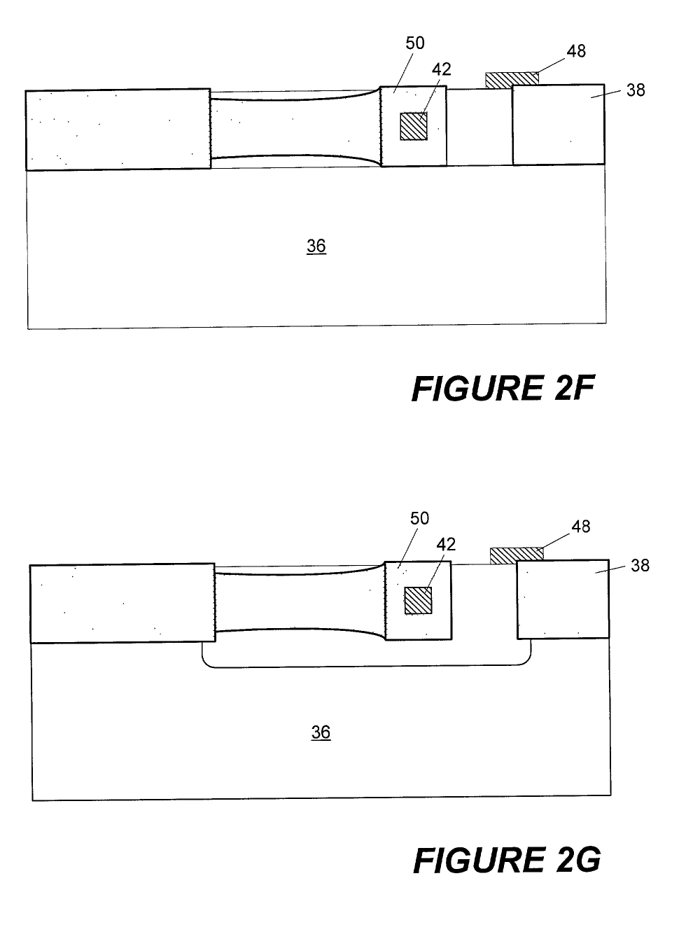

As mentioned above, the optical switch is formed on a single substrate through a series of deposition and etching steps. In particular, the process must include a step of etching that undercuts the arms 14, 16, so that they are free to move in response to the thermal changes. The dashed line 34 shown in FIG. 1 surrounds a region that is reduced by undercut etching following implementation of a fabrication method described herein. An example of such a fabrication process is described below in conjunction with FIGS. 2A-2G. Those skilled in the art will understand that this series of steps describes just one specific way to fabricate the optical switch, and that variations on this method may exist.

In FIGS. 2A-2G, the view is of a cross section of a switching apparatus during fabrication, the section being taken through a plane perpendicular to the plane of the page in FIG. 1, in a location and direction indicated by the section line II-II. In a first step of the method, shown in FIG. 2A, a substrate 36 has deposited on it a layer of a material 38 having a relatively low index of refractive index. A good candidate for this material is silicon dioxide (SiO₂), which may be deposited by flame hydrolysis deposition (FHD), a known vacuum deposition method. This layer will serve to provide a refractive index boundary for the core of the input waveguide 12 of the switch. Following deposition of the layer 38, another layer is deposited, also preferably by FHD. This layer, shown in FIG. 2B, is a material 40 with a refractive index that is significantly higher than that of the material 38. When the layer 38 is SiO₂, a good choice for the material 40 is SiO₂ with a dopant added to raise the refractive index. For example, by adding a dopant such as germanium to SiO₂ during deposition, a layer is produced that has a significantly higher refractive index than the SiO₂ alone.

After deposition of the layer 40, the material in that layer is selectively etched to remove all but several channels of higher refractive index material that will correspond to the respective waveguide cores for the switch. In the preferred embodiment, reactive ion etching is used, although any of a variety of known methods of selective etching may be used as well. The technique of reactive ion etching is known in the art, and the specific steps involved are not repeated herein, nor depicted in the figures. Those skilled in the art will be also familiar with other existing methods of selectively removing portions of the material 40. Following the etching, the several channels of higher refractive index material are left, and are shown in FIG. 2C. Although different configurations are possible, the channels in FIG. 2C correspond to the input and output waveguides of FIG. 1. In particular, the channel 42 of FIG. 2C corresponds to input waveguide 12 of FIG. 1, and channels 44 and 46 of FIG. 2C correspond, respectively, to output waveguides 22 and 20 of FIG. 1. Those skilled in the art viewing FIG. 2C will understand that the channels extend significantly in a direction perpendicular the drawing page, as well as parallel to it.

Once the channels 42, 44 and 46 are formed, further deposition of material 38 takes place. As shown in FIG. 2D, the additional deposition, also preferably by FHD, raises the level of the material 38 so that it completely covers the channels 42, 44 and 46. Indeed, the material 38 surrounds the channels on all sides and, having a lower index of refraction than that of the core material 40, serves as a cladding for the respective waveguides. Because of the cross sectional nature of FIG. 2D, only one surface of channel 42 is visible and, because of the location at which the section is taken, channels 44 and 46 are entirely hidden behind the cladding material 38.

With the core and cladding portions of the waveguides in place, the heater pads for coupling heat to the arms of the switch are deposited on the material 38 layer. The pads may be of a metal material, and a preferred method for forming the pads is by sputtering deposition. One of the heater pads is shown in FIG. 2E. Again, although not necessary, the location of the pad 48 is kept consistent with its location in FIG. 1 (in which it corresponds to pad 24), to assist in describing the invention. Due to the location at which the cross section of FIG. 2E is taken, the second heating pad shown in FIG. 1 is not visible in FIG. 2E.

FIG. 2F is taken along the same section line as the rest of FIGS. 2A-2G, and depicts a step in which deep reactive ion etching is used to remove large sections of the material 38. As is known in such an etching process, a photoresist material is developed on the material 38 layer at the locations where the arms 14, 16 are to be located, and all of the other area outside of the open region 17 within which the arms reside in FIG. 1. When the material 38 is etched, the portions of the material 38 that correspond to arms 14 and 16 are isolated from the rest of the material except at the contact points at either side of the open region 17. In FIG. 2F, the segment 50 of material 38 will correspond to arm 14 of FIG. 1. The segment corresponding to the arm 16 is not visible in the view of FIG. 2F. At this stage of the fabrication process, the arms 14, 16 are still attached to the material layer beneath them.

In order to free the arms from the underlying material, an “undercut etch” is performed. An etching solution that is applied to the open region 17 removes more of the material 38, including portions residing under the segments corresponding to arms 14, 16. In fact, in the preferred embodiment, a portion of the underlying substrate 36 is also removed beneath the open region. The etching solution not only eats downward into the silicon base, making it deeper, and also eats laterally into the side walls of the open region. This etching process removes the material that lies below the sections corresponding to arms 14, 16, thereby freeing them from any restriction except at the side contact points. Using the same cross sectional view as before, the resulting configuration is depicted in FIG. 2G. As shown, the segment 50 is disconnected from the underlying structure, and a portion of the substrate 36 is removed, creating a shallow pocket that corresponds to the area identified by dashed line 34 of FIG. 1.

While the invention has been shown and described with reference to a preferred embodiment thereof, it will be recognized by those skilled in the art that various changes in form and detail may be made herein without departing from the spirit and scope of the invention as defined by the appended claims. For example, although the preferred embodiment specifies certain materials for the planar waveguide and the surrounding structure, those skilled in the art will quickly identify analogous materials that may be substituted. The waveguides may be glass or silicon, or other materials known to be useful for such purposes. The configuration of the switch may also be modified without departing from the nature of the invention. The preferred embodiment suggests the use of a wishbone-shaped movable element, but other shapes are anticipated, and would operate in an analogous manner. Likewise, those skilled in the art will understand that, while the preferred embodiment is shown as a 1×2 optical switch, the principles disclosed herein apply to numerous different types of switching arrangements. In addition, known techniques for optimizing performance should be incorporated herein, such as compensation for any birefringence on the waveguide due to stress during its displacement. Naturally, known coupling strategies for optimizing the coupling between the input and output waveguides should also be implemented. Finally, means of changing the position of a movable component in the switch other than thermal expansion may also be used.

What is claimed is:

1. An optical switch comprising:
a substrate;
a first planar waveguide fabricated on the substrate;
a second planar waveguide fabricated on the substrate and provided with a degree of freedom that allows at least a portion of it to be moved between a first position in which it is aligned with the first planar waveguide such that an optical signal can be coupled between the second and first waveguides, and a second position in which it is not aligned with the first waveguide.

2. An optical switch according to claim 1 wherein the first and second waveguides are each surrounded by a respective cladding material that is also fabricated on the substrate.

3. An optical switch according to claim 1 wherein the switch comprises a layer of material that is located on top of the substrate and that is used to form a movable structure to which the second waveguide is rigidly fixed.

4. An optical switch according to claim 3 wherein the movable structure is fixed relative to the substrate at a first point.

5. An optical switch according to claim 3 wherein the layer of material is a deposited layer on the substrate that has been etched to form the movable structure.

6. An optical switch according to claim 5 wherein a portion of the substrate below the movable structure has been removed.

7. An optical switch according to claim 3 wherein the movable structure is in contact with a heat source, and movement of the movable structure is caused by activation of the heat source and corresponding thermal expansion of the material of the movable structure.

8. An optical switch according to claim 7 wherein the movable structure has a wishbone shape.

9. An optical source according to claim 7 wherein the heat source includes a heater contact pad that is fabricated on the switch by deposition.

10. An optical source according to claim 7 wherein the heat source includes an electrical resistance heating element.

11. An optical source according to claim 10 wherein the resistance heating element is embedded in the movable structure.

12. An optical switch according to claim 3 wherein the movable structure comprises a material that surrounds the second waveguide and that has an index of refraction that differs significantly enough from that of the waveguide material as to allow a total internal reflection condition within the waveguide for light at a desired wavelength.

13. An optical switch according to claim 12 wherein the movable structure is part of a deposition layer that is deposited on the substrate wherein selected portions of the layer were removed, other portions of the deposition layer being in rigid contact with the first waveguide.

14. An optical switch according to claim 3 further comprising a stop against which the movable structure makes contact when the second waveguide is in the second position.

15. An optical switch according to claim 1 further comprising a third planar waveguide fabricated on the substrate, the third waveguide being aligned with the second waveguide when the second waveguide is in the second position.

16. An optical switch comprising:
a substrate;
a layer of core material suitable for use as the core of a planar waveguide, the core material having been deposited on the substrate and selectively etched to form a first planar waveguide and a second planar waveguide on the substrate;
a layer of cladding material suitable for use as a cladding surrounding a planar waveguide, the cladding material having been deposited on the substrate and selectively etched to form sections surrounding the first and second waveguides, one of said sections including a movable structure that moves relative to the remaining section, the second waveguide being secured to the movable structure such that it moves between a first position in which it is aligned with the first planar waveguide such that an optical signal can be coupled between the second and first waveguides, and a second position in which it is not aligned with the first waveguide; and
an actuation mechanism that, when activated, causes the movable structure to move the second waveguide from the first position to the second position.

17. An optical switch according to claim 16 wherein the movable structure is fixed relative to the substrate at a first point.

18. An optical switch according to claim 16 wherein a portion of the substrate below the movable structure has been removed.

19. An optical switch according to claim 16 wherein the actuation mechanism comprises a heat source, and movement of the movable structure is caused by activation of the heat source and corresponding thermal expansion of the material of the movable structure.

20. An optical switch according to claim 16 wherein the movable structure has a wishbone shape.

21. An optical switch according to claim 16 further comprising a third planar waveguide fabricated on the substrate, the third waveguide being aligned with the second waveguide when the second waveguide is in the second position.

22. An optical switch according to claim 16 further comprising a stop against which the movable structure makes contact when the second waveguide is in the second position.

23. A method of fabricating an optical switch, the method comprising:
providing a substrate;
locating on the substrate a first planar waveguide;
locating on the substrate a second planar waveguide, the second waveguide having a degree of freedom that allows it to move between a first position in which it is aligned with the first planar waveguide such that an optical signal can be coupled between the second and first waveguides, and a second position in which it is not aligned with the first waveguide; and
providing an actuation mechanism that, when activated, causes the second waveguide to move from the first position to the second position.

24. A method according to claim 23 wherein the first and second waveguides are each surrounded by a respective cladding material that is also fabricated on the substrate.

25. A method according to claim 23 wherein the switch comprises a layer of material that is located on top of the substrate and that has used to form a movable structure to which the second waveguide is rigidly fixed.

26. A method according to claim 25 wherein the movable structure is fixed relative to the substrate at a first point.

27. A method according to claim 25 wherein the layer of material is a deposited layer on the substrate that has been etched to form the movable structure.

28. A method according to claim 27 wherein a portion of the substrate below the movable structure has been removed.

29. A method according to claim 25 wherein the movable structure is in contact with a heat source, and movement of the movable structure is caused by activation of the heat source and corresponding thermal expansion of the material of the movable structure.

30. A method according to claim 25 wherein the movable structure has a wishbone shape.

31. A method according to claim 25 wherein the heat source includes a heater contact pad that is fabricated on the switch by deposition.

32. A method according to claim 25 wherein the heat source includes an electrical resistance heating element.

33. A method according to claim 28 wherein the resistance heating element is embedded in the movable structure.

34. A method according to claim 25 wherein the movable structure comprises a material that surrounds the second waveguide and that has an index of refraction that differs significantly enough from that of the waveguide material as to allow a total internal reflection condition within the waveguide for light at a desired wavelength.

35. A method according to claim 34 wherein the movable structure is part of a deposition layer that is deposited on the substrate wherein selected portions of the layer were removed, other portions of the deposition layer being in rigid contact with the first waveguide.

36. A method according to claim 25 further comprising a stop against which the movable structure makes contact when the second waveguide is in the second position.

37. A method according to claim 23 further comprising a third planar waveguide fabricated on the substrate, the third waveguide being aligned with the second waveguide when the second waveguide is in the second position.

38. A method of fabricating an optical switch, the method comprising:
providing a substrate;
depositing on the substrate a layer of core material suitable for use as the core of a planar waveguide;
selectively etching the core material to form a first planar waveguide and a second planar waveguide on the substrate;
depositing on the substrate a layer of cladding material suitable for use as a cladding surrounding a planar waveguide;
selectively etching the cladding material to form sections surrounding the first and second waveguides, one of said sections including a movable structure that moves relative to the remaining section, the second waveguide being secured to the movable structure such that it moves between a first position in which it is aligned with the first planar waveguide such that an optical signal can be coupled between the second and first waveguides, and a second position in which it is not aligned with the first waveguide; and
providing an actuation mechanism that, when activated, causes the movable structure to move the second waveguide from the first position to the second position.

39. A method according to claim 38 wherein the movable structure is fixed relative to the substrate at a first point.

40. A method according to claim 38 wherein a portion of the substrate below the movable structure has been removed.

41. A method according to claim 38 wherein the actuation mechanism comprises a heat source, and movement of the movable structure is caused by activation of the heat source and corresponding thermal expansion of the material of the movable structure.

42. A method according to claim 38 wherein the movable structure has a wishbone shape.

43. A method according to claim 38 further comprising a third planar waveguide fabricated on the substrate, the third waveguide being aligned with the second waveguide when the second waveguide is in the second position.

44. A method according to claim 38 further comprising a stop against which the movable structure makes contact when the second waveguide is in the second position.
